(19) United States
(12) Patent Application Publication
(10) Pub. No.: US 2016/0050386 A1
(43) Pub. Date: Feb. 18, 2016

(54) TRANSPORT OF ANALOG VIDEO SIGNALS VIA DIGITAL VIDEO CABLES

(71) Applicant: Quality Manufactured Accessories Inc., Chicago, IL (US)

(72) Inventor: Mohammed Alzoubi, Bridgeview, IL (US)

(73) Assignee: Quality Manufactured Accessories Inc., Chicago, IL (US)

(21) Appl. No.: 14/826,949

(22) Filed: Aug. 14, 2015

Related U.S. Application Data
(60) Provisional application No. 62/038,197, filed on Aug. 15, 2014.

(51) Int. Cl. H04N 5/77; H04N 7/18; H04N 5/232

(52) U.S. Cl. CPC H04N 5/77; H04N 5/23241; H04N 7/181

(57) ABSTRACT

A system is described for transmitting analog video signals over digital video cables. The system may comprise one or more analog video sources; a digital video cable, wherein the video cable may be composed of multiple wires for transmitting digital signals; a first adaptation bridge, wherein each analog video source may be connected to a unique wire of the digital video cable; a second adaptation bridge, wherein each wire of the digital video cable that may be carrying an analog video signal may be connected to an analog video cable.

### CROSS-REFERENCE TO RELATED APPLICATIONS

This application claims the benefit of, and priority to, U.S. Provisional Patent Application Ser. No. 62/038,197, filed Aug. 15, 2014, the entire disclosure of which is incorporated herein by reference.

### BACKGROUND

1. Field of the Invention

The present disclosure relates to devices and systems for transmitting analog video signals.

2. Description of the Related Art

Traditional CCTV systems often require that installers run a coaxial cable from each CCTV camera to a video recorder. If a site has multiple CCTV cameras, this approach can require running large bundles of coaxial cables, which can be difficult to install or conceal. In addition, relocating components of the CCTV system, such as a video recorder, can impose considerable cost in time and money due to the need to extend or relocate all of the coaxial cables involved.

### SUMMARY

A system is described for transmitting analog video signals over digital video cables. The system may comprise one or more analog video sources; a digital video cable, wherein the video cable may be composed of multiple wires for transmitting digital signals; a first adaptation bridge, wherein each analog video source may be connected to a unique wire of the digital video cable; a second adaptation bridge, wherein each wire of the digital video cable that may be carrying an analog video signal may be connected to an analog video cable.

### DETAILED DESCRIPTION OF THE FIGURES

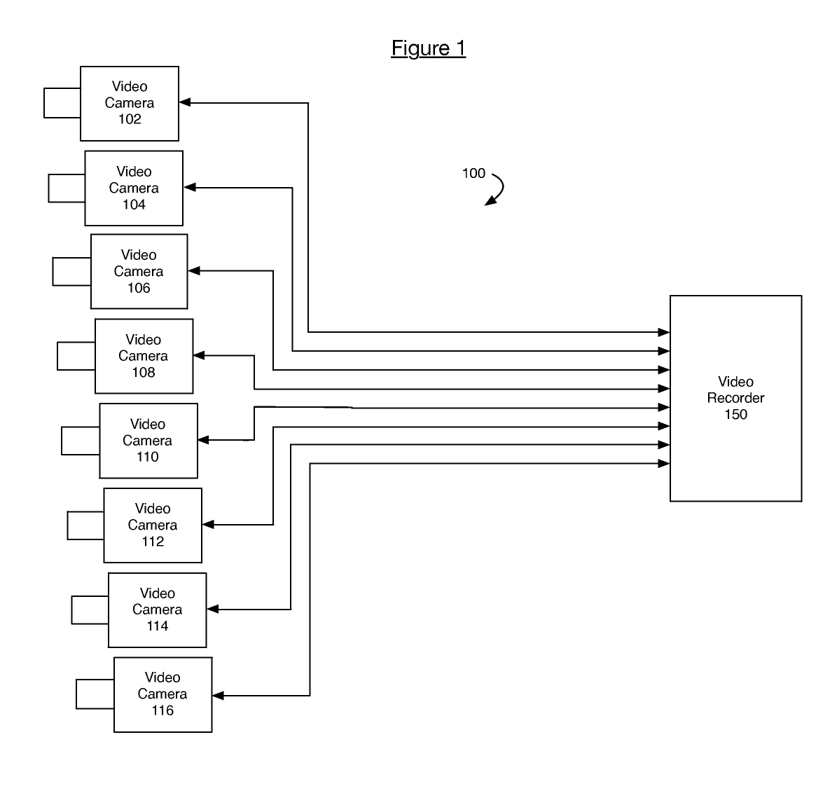

FIG. 1 shows an example of a CCTV system.

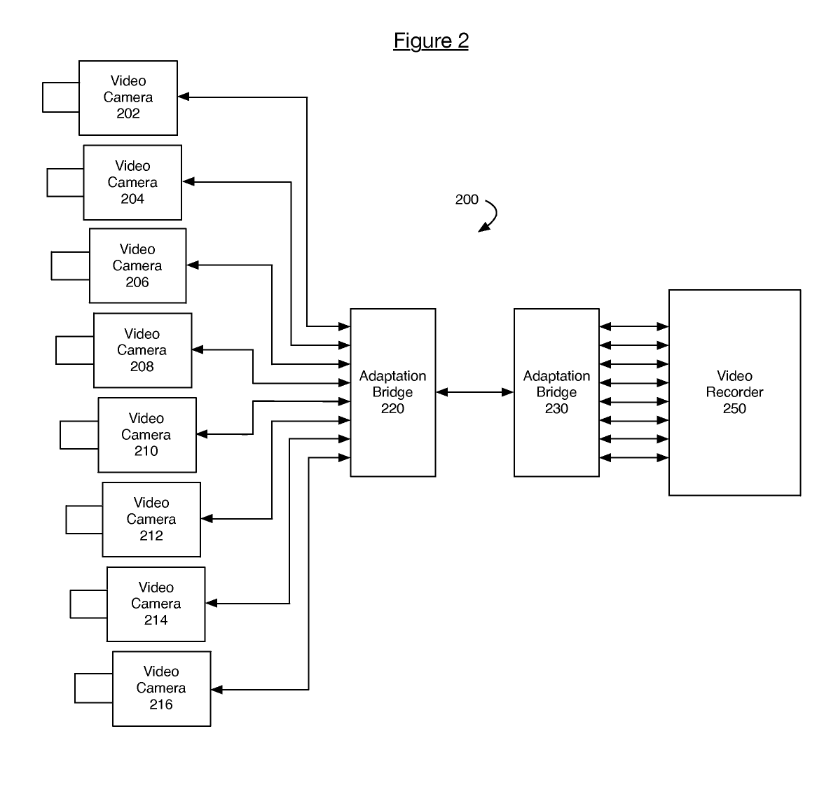

FIG. 2 shows an example of a system for bundling CCTV video signals in a CCTV system.

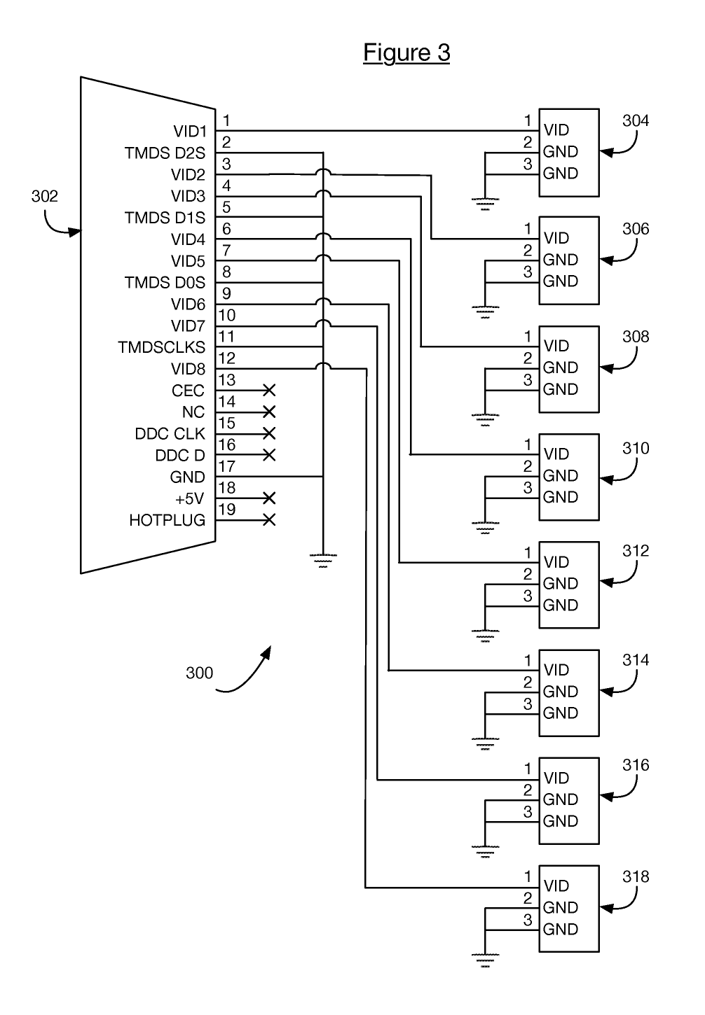

FIG. 3 shows an example of an Adaptation Bridge 300.

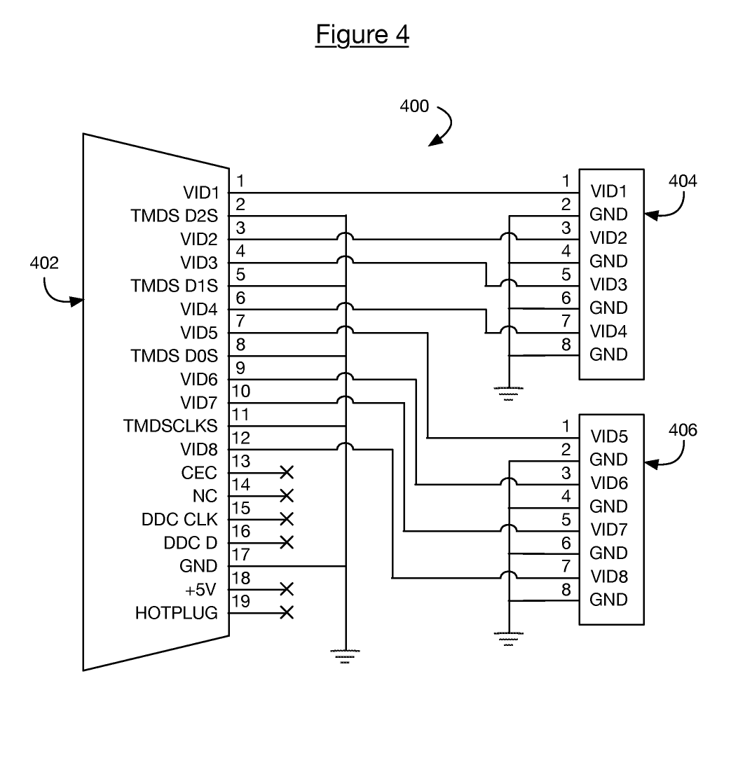

FIG. 4 shows an example of an Adaptation Bridge 400.

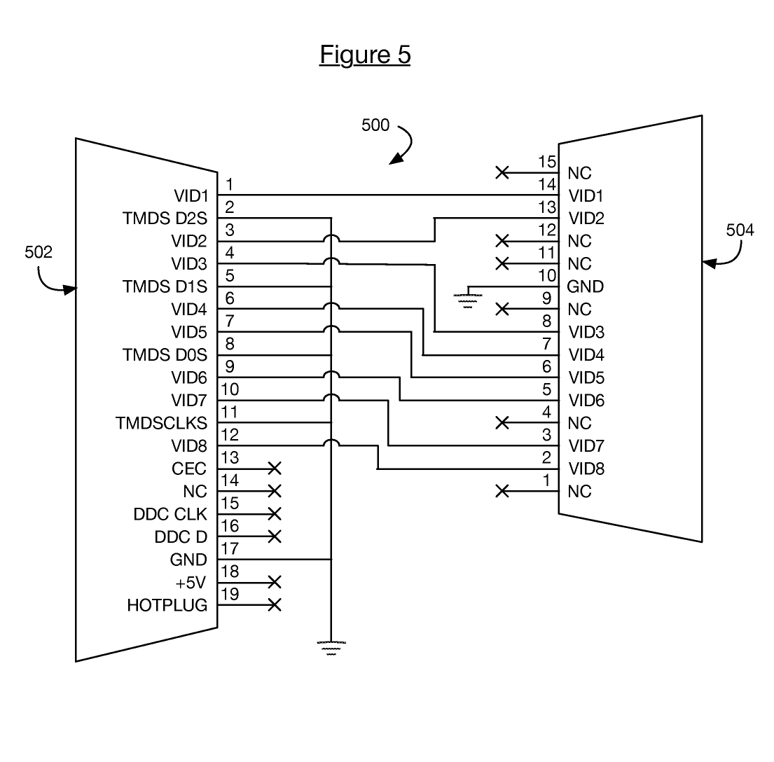

FIG. 5 shows an example of an Adaptation Bridge 500.

### DETAILED DESCRIPTION OF THE PREFERRED EMBODIMENTS

The present disclosure describes devices and systems for transmitting analog video signals.

FIG. 1 shows an example of a closed-circuit television (“CCTV”) system known in the art. In such a CCTV system, one or more CCTV cameras (e.g., Video Camera 102-116) may be connected by a coaxial cable from each CCTV camera to a Video Recorder 150. The video signals used in such an installation are typically analog video signals with a resolution of 720×480 (“D1 Resolution”). In addition, each CCTV camera must also be supplied with a connection to a power source. Such a power source may be obtained from various sources, such as a battery or power outlet, which is not shown in FIG. 1.

With the advent of digital computer monitors and digital television, digital video cables have been developed to specifically support the transmission of digital video signals. For example, a High-Definition Multimedia Interface (“HDMI”) cable may be designed according to the EIA/CEA-861 standard. Such HDMI cables are typically constructed using a cable composed of 19 unique wires attached to 19-pin connectors (e.g., HDMI Type A plugs) at each end. Such HDMI cables are specifically designed to transport digital video signals or other forms of digital information (e.g., HDMIT Ethernet, digital audio signals). The EIA/CEA-861 standard requires that many of the wires in an HDMI cable must each be able to carry a digital signal requiring considerable bandwidth. For example, EIA/CEA-861-B (“HDMI 1.0”) requires that HDMI cables support a minimum pixel clock rate of 165 MHz, while EIA/CEA-861-D (“HDMI 1.3”) requires a minimum pixel clock rate of 340 MHz. Consequently, the wires used to convey digital video signals in an HDMI cable individually have more than sufficient bandwidth to transmit a single analog video signal in common use.

FIG. 2 shows an example of a system for bundling CCTV video signals in a CCTV system. The system may have one or more CCTV cameras (e.g., Video Camera 202-216). Each CCTV camera may be connected to an Adaptation Bridge 220, such as by a coaxial cable. Coaxial cables may use Bayonet Neill-Concelman (“BNC”) connectors to form connections to a CCTV camera and the Adaptation Bridge 220. At the Adaptation Bridge 220, each individual analog video signal from a CCTV camera may be connected to an individual wire of a digital video cable. An example of such an approach is described herein with respect to FIG. 3 for multiple-BNC-to-HDMI.

From Adaptation Bridge 220 to Adaptation Bridge 230, a single digital video cable may be used to transport the one or more analog video signals. In some embodiments, one or more digital video cables may be used to connect Adaptation Bridge 220 to Adaptation Bridge 230. At Adaptation Bridge 230, each wire of a digital video cable carrying an analog video signal may be connected to a separate connector (e.g., BNC).

From Adaptation Bridge 230, one or more analog video signals may be transmitted by individual cables to Video Recorder 250, such as via one or more coaxial cables. At Video Recorder 250, the one or more analog video signals may be recorded or otherwise processed.

In some embodiments, Adaptation Bridge 220 may include a Power Distribution Component 240. Power Distribution Component 240 may be connected to a power source, such as a power outlet or battery, and may provide primary or backup power to one or more CCTV cameras via one or more power cords.

In some embodiments, Adaptation Bridge 230 may be integrated with Video Recorder 250, such that a digital video cable carrying multiple analog video signals may connect to the Video Recorder 250.

In some embodiments, Adaptation Bridge 220 or 230 may include amplifiers for boosting the signal of one or more analog video signals.

FIG. 3 shows an example of an Adaptation Bridge 300. HDMI Connector 302 may be connected to eight BNC Connectors 304-318. Pin 1 of HDMI Connector 302 may be connected to Pin 1 of BNC Connector 304 to convey a first analog video signal. Pin 3 of HDMI Connector 302 may be connected to Pin 1 of BNC Connector 306 to convey a second analog video signal. Pin 4 of HDMI Connector 302 may be connected to Pin 1 of BNC Connector 308 to convey a third analog video signal. Pin 6 of HDMI Connector 302 may be connected to Pin 1 of BNC Connector 310 to convey a fourth analog video signal. Pin 7 of HDMI Connector 302 may be connected to Pin 1 of BNC Connector 312 to convey a fifth analog video signal. Pin 9 of HDMI Connector 302 may be connected to Pin 1 of BNC Connector 314 to convey a sixth analog video signal. Pin 10 of HDMI Connector 302 may be connected to Pin 1 of BNC Connector 316 to convey a seventh analog video signal. Pin 12 of HDMI Connector 302 may be connected to Pin 1 of BNC Connector 318 to convey a eighth analog video signal. Pins 13-16 and 18-19 of HDMI Connector 302 may be left unconnected. Pins 2, 5, 8, 11, and 17 of HDMI Connector 302 may be connected to ground. Pins 2-3 of BNC Connectors 304-318 may be connected to ground.

FIG. 4 shows an example of an Adaptation Bridge 400. HDMI Connector 402 may be connected to two Terminal Connectors 404-406. Pins 1, 3, 4, and 6 of HDMI Connector 402 may be connected, respectively, to Pins 1, 3, 5, and 7 of Terminal Connector 404 to convey a first, second, third, and fourth analog video signal. Pins 7, 9, 10, and 12 of HDMI Connector 402 may be connected, respectively, to Pins 1, 3, 5, and 7 of Terminal Connector 404 to convey a fifth, sixth, seventh, and eighth analog video signal. Pins 13-16 and 18-19 of HDMI Connector 402 may be left unconnected. Pins 2, 5, 8, 11, and 17 of HDMI Connector 402 may be connected to ground. Pins 2, 4, 6, and 8 of Terminal Connectors 304-306 may be connected to ground.

FIG. 5 shows an example of an Adaptation Bridge 500. HDMI Connector 502 may be connected to a VGA Connector 504. Pins 1, 3, 4, 6, 7, 9, 10, and 12 of HDMI Connector 502 may be connected, respectively, to Pins 14, 13, 8, 7, 6, 5, 3, and 2 of VGA Connector 504 to convey a first, second, third, fourth, fifth, sixth, seventh, and eighth analog video signal. Pins 13-16 and 18-19 of HDMI Connector 502 may be left unconnected. Pins 1, 4, 9, 11, 12, and 15 of VGA Connector 504 may be left unconnected. Pins 2, 5, 8, 11, and 17 of HDMI Connector 502 may be connected to ground. Pin 10 of VGA Connector 504 may be connected to ground. Adaptation Bridge 500 may be used in some embodiments where it is preferable to use an analog video cable capable of carrying multiple analog video signals instead of a digital video cable.

The advantage of the devices and systems described herein will be to reduce labor, materials (e.g., cables), to make the connection to a video recorder less complicated, and to make the installation appear neater by reducing runs of multiple analog video cables to fewer digital video cables. Also, these products may be used to make it easy for an installer to extend and move a video recorder from one location to another without extending multiple analog video cables. Instead, the installer may use an Adaptation Bridge to connect multiple analog video cables to one or more digital video cables, and then use another Adaptation Bridge for connecting the multiple CCTV cameras to the video recorder.

The disclosure and examples above are intended to be illustrative and are not intended to limit or otherwise restrict the invention. Numerous variations and modifications will become apparent to those skilled in the art upon full appreciation of the above disclosure. For example, the description of devices and systems herein is not limited to only CCTV cameras, but may be used for any device or system that outputs analog video signals. In addition, the description of devices and systems herein is not limited to only HDMI cables for conveying bundled analog video signals, but rather may be used with any digital video cable that has sufficient bandwidth to transmit analog video signals in common use on individual wires of the digital video cable (e.g., DVI). The description of devices and systems herein is also not limited to only coaxial cables for conveying individual analog signals, but rather may use any type of cable sufficient for conveying individual analog signals. The Pin assignments described herein are exemplary, as other arrangements or permutations may be used, provided that the wires of a digital video cable utilized offer sufficient bandwidth to convey the desired analog video signal(s). While FIGS. 3-5 show examples of Adaptation Bridges for connecting 8 analog video signals to a digital video cable, it should be understood that less or more analog video signals and associated connectors may be used in an Adaptation Bridge, provided that there are a sufficient number of wires in one or more digital video cables connected to an Adaptation Bridge for conveying the desired number of analog video signals. In addition, the systems and devices disclosed herein may utilize one or more baluns to convert a balanced analog video signal to an unbalanced analog video signal. All references cited herein are expressly incorporated by reference.

What is claimed is:

1. A system for transmitting one or more analog video signals over a digital video cable comprising:
one or more analog video ports for receiving the analog video signals;
the digital video cable, wherein the video cable is composed of multiple wires for transmitting digital signals;
a first adaptation bridge, wherein each analog video port is connected to a unique wire of the digital video cable; and
a second adaptation bridge, wherein each wire of the digital video cable that is carrying an analog video signal is connected to an analog video cable.

2. A system according to claim 1, wherein said first adaptation bridge further comprises a power distribution component for distributing power to video cameras.

3. A system according to claim 1, wherein said second adaptation bridge is integrated into a video recorder.

4. A system according to claim 1, wherein the digital video cable is an HDMI cable.

5. A system according to claim 1, wherein the digital video cable is a DVI cable.

6. A system according to claim 1, wherein each unique wire of the digital video cable was designed for use with digital video signals.

7. A method for transmitting one or more analog video signals via a digital video cable comprising the steps of:
receiving the analog video signals;
using a first adaptation bridge to couple each analog video signal to a unique wire of the digital video cable, wherein the digital video cable comprises multiple wires for transmitting digital signals; and
using a second adaptation bridge to couple each wire of the digital video cable that is carrying an analog video signal to an analog video cable.

8. A method according to claim 7, further comprising the step of providing a power distribution component within the first adaptation bridge for distributing power to video cameras.

9. A method according to claim 7, wherein said second adaptation bridge is integrated into a video recorder.

10. A method according to claim 7, wherein the digital video cable is an HDMI cable.

11. A method according to claim 7, wherein the digital video cable is a DVI cable.

12. A method according to claim 7, wherein each unique wire of the digital video cable was designed for use with digital video signals.

13. A device for conveying one or more analog video signals via a digital video cable comprising:
one or more analog video ports capable of receiving or transmitting the analog video signals;
a digital video port for connecting to the digital video cable, wherein the digital video port comprises multiple wires for receiving or transmitting digital signals;
an adaptation bridge, wherein each analog video port is connected to a unique wire of the digital video port.

14. A device according to claim 13, wherein said adaptation bridge further comprises a power distribution component for distributing power to video cameras.

15. A device according to claim 13, wherein said device is integrated into a video recorder.

16. A device according to claim 13, wherein the digital video cable is an HDMI cable.

17. A device according to claim 13, wherein the digital video cable is a DVI cable.
